(19) United States
(12) Patent Application Publication
(10) Pub. No.: US 2026/0191211 A1
(43) Pub. Date: Jul. 9, 2026

(54) FOOD PROCESSING MACHINE WITH CONTROL DEVICE AND OPERATING METHOD

(71) Applicant: VEMAG Maschinenbau GmbH, Verden (DE)

(72) Inventors: Manuel Otten, Kirchlinteln (DE); Thomas Zarezki, Ludwigslust (DE)

(21) Appl. No.: 19/443,817

(22) Filed: Jan. 8, 2026

(30) Foreign Application Priority Data
Jan. 9, 2025 (DE) 102025100600.8

(51) Int. Cl. A22C 11/02; A23B 4/052; B65G 17/06

(52) U.S. Cl. CPC A22C 11/0245; A23B 4/052; B65G 17/06; B65G 2201/0202; B65G 2811/097

(57) ABSTRACT

A food processing machine is provided for producing food products. The food processing machine includes a suspension apparatus having a plurality of suspension hooks that are coupled to a drive train, a drive unit that moves the suspension hooks along a predefined transport path, and a control device that controls the food processing machine in a loading mode. The control device actuates the drive unit to drive the drive train in a transport direction. At least one transfer device that is set up to transfer a food product to the suspension apparatus in a transfer are during the loading mode. The control device also controls the food processing machine in a correction mode, in which the control device is embodied to actuate the drive unit to drive the drive train counter to the transport direction.

### CROSS-REFERENCE TO RELATED APPLICATION

This application claims priority to German Application No. DE 10 2025 100 600.8, filed Jan. 9, 2025. The above-mentioned patent application is incorporated herein by reference in its entirety.

### TECHNICAL FIELD

This application relates to a food processing machine for producing food products. This application also relates to a control device for such a food processing machine and to an operating method.

### BACKGROUND

In the present case, a food processing machine is understood to be a combination of different food processing machines, which can also be operated individually and which are embodied for producing and transporting food products. This comprises at least the drive train, the suspension apparatus, a transfer device, and a control device.

A food processing machine known in the prior art is disclosed in Japanese Patent Application Publication No. JP 2022 39 156 A.

In the food processing sector, it is common to use food processing machines that automate various steps of food production. Known systems typically comprise transfer devices such as conveyor belts or transport chutes, suspension apparatuses, and control devices, which all work together to efficiently process and transport food products. These food processing machines are often designed to move food products from one station to the next in a continuous process, with the aim of automating as many of the process steps as possible in order to maximize the efficiency and consistency of production. One application sector for such food processing machines is sausage production. Individual units of such food processing machines preferably fill sausage strands, twist them into links, and portion them into sausage chains before they are transferred to suspension hooks for further processing.

According to known technologies, these food processing machines are generally designed to move food in a fixed transport direction. This means that the food products are continuously moved from one station to the next along a predefined transport path. But various problems can occur during this process, such as casing ruptures, fill level deficits, or weight deviations, which lead to stoppages in production and to an absence of food products. This results in a lower productivity in downstream processes, particularly when transferring food products from the transfer device to the suspension apparatus, since the suspension apparatus is not fully loaded and as a result, downstream processes also cannot be operated at full capacity. In sausage production, for example, the food products in the form of sausages are transferred from the suspension apparatus to smoke rods, which are then not fully loaded due to such disruptions in the production operation and as a result, the smoking or cooking chambers into which the smoke rods are usually moved for further processing are also not fully utilized.

It would therefore be desirable to provide a food processing machine that at least partially overcomes the disadvantages of known systems. In particular, the technical problem of the present invention is to increase productivity in food production.

### SUMMARY

In a first aspect, the present invention provides a food processing machine.

The food processing machine comprises a suspension apparatus with a plurality of suspension hooks that are coupled to a drive train. These suspension hooks can be moved along a predefined transport path by a drive unit that is operatively connected to the drive train. The drive unit enables the movement of the suspension hooks and is therefore a central component of the transport mechanism.

In the present case, the drive train refers to one or more components of the suspension apparatus that couple the suspension hooks to the drive unit in such a way that the drive torque of the drive unit produces a movement of the suspension hooks along the transport path.

A control device is set up to control the food processing machine in a loading mode. This control device actuates the drive unit of the drive train in a specified transport direction. The communication between the control device and the drive unit takes place by electrical or electronic signals that activate the drive unit and coordinate the movement of the suspension hooks.

At least one transfer device is provided, which is set up to transfer a food product to the suspension apparatus in a transfer area. This transfer device mechanically interacts with the suspension hooks by bringing the food product into the area in which the suspension hooks can pick up the food product. The transfer device and the suspension apparatus are thus matched to each other mechanically and spatially. The transfer device is strategically positioned to enable a smooth transfer of the food products to the suspension hooks, while the control device ensures the precise synchronization of the movements. These technical features can help overcome the challenges of automating food production by enabling more precise and efficient handling of the food products while improving flexibility and error correction in operations.

In the loading mode, the suspension hooks are set up to be moved sequentially into the transfer area as they move along the transport path. This enables the suspension hooks to pick up at least one part of the food product from the transfer device. The synchronization between the movement of the suspension hooks and the positioning of the food products by the transfer device is crucial for the smooth operation of the food processing machine.

With regard to a food processing machine of the type mentioned at the beginning, the invention proposes in particular for the control device to be set up to control the food processing machine in a correction mode. In this connection, the control device is embodied to actuate the drive unit to drive the drive train counter to the transport direction. In other words, the control device is embodied and, from a control standpoint, connected to the drive unit in such a way that it can actuate the drive unit to drive the drive train counter to the transport direction. This makes it possible to make corrections by moving the suspension hooks in reverse. Here, too, the communication between the control device and the drive unit is carried out by corresponding control commands that reverse the movement direction of the drive unit. This function can be particularly useful for correcting errors that can occur in the loading mode, for example missing portions of food or production errors such as casing ruptures. The ability to reverse the direction of the drive train allows the food processing machine to respond flexibly to various operating conditions and increases overall productivity and reliability.

In addition, other advantageous embodiments ensue as described below.

According to the invention, a hook spacing between two successive suspension hooks is stored in the control device. This means that the control device stores and manages information about the specific distance between the suspension hooks. This information is crucial for precisely controlling the movement of the suspension hooks along the transport path. The control device is also set up to produce a control pulse that actuates the drive unit to drive the drive train counter to the transport direction in such a way that the suspension hooks each move the distance of this hook spacing counter to the transport direction. This implies that the control device is able to generate specific control pulses that cause the drive unit to move the drive train by precisely the distance of the stored hook spacing counter to the transport direction that is used in loading mode. This enables an exact and fully automatable correction option in the event of an incorrect positioning of the food product. This can significantly increase the efficiency and reliability of the food processing machine since errors can be quickly and precisely corrected. Furthermore, the stored information about the hook spacing allows the food processing machine to be flexibly adapted to different production requirements and food product sizes since the control device can be correspondingly programmed to take different hook spacings into account. This increases the versatility and adaptability of the food processing machine.

According to one embodiment, the food processing machine comprises an actuating device, in particular a push button, which is set up to cause the control device to produce the control pulse when it is manually actuated. This actuating device is an additional component that enables interaction between the user and the control device of the food processing machine. The actuating device, for example embodied in the form of a push button, acts as an interface that allows the user to intervene directly in the control process of the food processing machine. Manual actuation of the push button initiates a control pulse that is relayed to the control device. This control pulse serves as a signal that causes the control device to perform certain actions such as starting or stopping the drive unit that moves the suspension hooks via the drive train. As a result, an operator can for example first check the so-called residual length, i.e. the length of the hanging end of the last sausage loop picked up during sausage production. If this residual length is long enough, then part of it can be positioned on an empty hook and this hook then does not have to be moved back counter to the transport direction. The integration of the actuating device therefore increases the flexibility and user-friendliness of the food processing machine since it enables the user to initiate the correction mode quickly, easily and, above all, as needed. This contributes to the efficiency and precision of the overall production process. In addition, the actuating device enables direct and intuitive operation of the food processing machine, which reduces the need for complex and time-consuming programming or settings.

According to another embodiment, the control pulse is a first control pulse. In this case, the actuating device is set up, when it is manually actuated with at least a predefined minimum duration, to cause the control device to produce the first control pulse. This means that the food processing machine requires a manual actuation for a certain length of time in order to activate the first control pulse, which requires a deliberate and conscious operation by the user. This functionality could be used to prevent an accidental activation and to ensure that the user is intentionally switching the food processing machine into a particular operating mode. In addition, the actuation device is set up, with a manual actuation that is shorter than the predefined minimum duration, to cause the control device to produce a second control pulse to drive the drive train in the transport direction. This distinguishing between different actuation durations enables a differentiated control of the food processing machine, with short actuations initiating a different function than longer actuations. In concrete terms, this could mean that a short actuation initiates the usual loading mode and only the deliberate, longer actuation initiates the correction mode. This enables an increased precision and control in the operation of the food processing machine.

According to another embodiment, the transfer device comprises at least one control unit, wherein the control device is integrated into the control unit of the transfer device. The integration of the control device into the control unit of the transfer device ensures a direct and efficient communication between the transfer device and the control device. This means that the control commands and responses can be transmitted between these two components without delays or losses, which results in a more precise control of the transfer processes. This integration results in an improved synchronization of the movements of the suspension hooks and the transfer device, which increases the efficiency and precision of the loading mode. In addition, the integration of the control device into the control unit makes it possible to reduce the complexity of both the wiring and the control logic. This results in a simplified maintenance and fault diagnosis. The integration of the control device into the control unit of the transfer device also makes it possible to optimize the control algorithms and strategies since the transfer device and suspension apparatus are controlled from a single place. This can result in an improved output of the food processing machine since the control of the various components can be better coordinated.

According to another embodiment, the food processing machine also comprises a filling machine for filling an artificial or natural casing with a sausage filling. The control device of the food processing machine is associated with the filling machine, which means either that the filling machine is controlled by the central control device of the food processing machine or that the control device of the food processing machine is able to communicate with the controller of the filling machine. This enables a coordinated control of the suspension apparatus and the filling machine, allowing the overall production process to be more efficient. In particular, the control device of the food processing machine can be integrated into the filling machine controller, which means that the control of the filling machine and the control of the food processing machine are combined into a single control unit. This has the advantage that the communication between the two food processing machines is optimized since a separate interface is not required to connect the two control units to each other. Such an integration can shorten the reaction times and improve the synchronization of the two food processing machines, which can result in a higher production speed and an improved product quality. In addition, the integration of the control device into the filling machine controller can reduce the complexity of the overall food processing machine control since fewer separate control components are required. This can also simplify maintenance and fault rectification since all relevant control functions are combined into a single unit.

According to another embodiment, the food processing machine also comprises at least one casing rupture monitoring control section, which, in order to monitor for casing ruptures, communicates with at least one sensor, in particular an optical sensor, and with the control device. The optical sensor of the control section detects visual data that indicate the existence of a casing rupture and sends these data to the control device. This precise monitoring is particularly important in food production where the quality and safety of the products are extremely important. The control device is therefore set up so that when a casing rupture is identified, it actuates the drive unit to drive the drive train counter to the transport direction in the correction mode. This makes it possible to immediately react to detected casing ruptures and the accompanying production stoppages through a corresponding actuation of the suspension apparatus in order to initiate the correction mode. The combination of optical monitoring and automated control in the correction mode ensures that the food processing machine is able not only to detect such problems, but also to immediately take corrective measures.

According to this embodiment, the food processing machine also comprises at least one fill level monitoring control section, which, in order to monitor the fill level of a hopper of a filling machine of the food processing machine, communicates with a fill level sensor and with the control device. This communication takes place in particular via an interface that allows the fill level sensor to transmit data about the fill level of the hopper to the control device continuously or at regular intervals. The fill level sensor detects the current fill level of the hopper and sends this information to the control device, which then activates the fill level monitoring control section. This control section analyzes the received data and identifies whether there is a fill level deficit, i.e. whether the fill level of the hopper has fallen below a specified minimum value. If such a deficit has been identified, the control device is set up to actuate the drive unit to drive the drive train counter to the transport direction in the correction mode. The suspension hooks are thus moved counter to the transport direction and after the hopper has been refilled, the operation can continue and the suspension apparatus can be fully utilized.

According to another embodiment, the food processing machine also comprises at least one weight monitoring control section, which, in order to monitor the weight of the food products suspended on the suspension hooks, communicates with a weighing cell and with the control device. This communication between the weight monitoring control section and the control device typically takes place via a wired or wireless communication network, which makes it possible to send the weight data detected by the weighing cell to the control device in real time. The weighing cell measures the weight of the food products suspended from the suspension hooks continuously or at intervals and sends these data to the weight monitoring control section, which analyzes them and, depending on the case, identifies a weight deficit. If a weight deficit is identified, the weight monitoring control section also at least sends a signal to the control device that causes the latter to actuate the drive unit to drive the drive train counter to the transport direction in the correction mode. It is thus possible to react to production stoppages that occur in reaction to a weight deficit—for example in order to carry out adjustments to a filling machine. This reverse movement of the drive train makes it possible to move the suspension hooks back into a position in which when the loading mode resumes, they can then take transferred food products, and thus ensures a full utilization of the suspension apparatus and downstream processes.

According to another embodiment, the food processing machine comprises at least one production malfunction monitoring control section, which is set up to monitor production malfunctions of the food processing machine. This control section communicates with at least one controller and/or at least one control unit of the food processing machine and with the control device. The production malfunction monitoring control section continuously monitors the operation of the food processing machine and identifies potential malfunctions or anomalies in the production process. This information is then relayed to the control device, which then takes appropriate corrective measures. In particular, in the event that a production malfunction is identified, the control device is set up to actuate the drive unit to drive the drive train counter to the transport direction in the correction mode. This means that the food processing machine is able to immediately react to detected malfunctions and the accompanying production stoppages by causing the food products to be transported in the opposite direction. The integration of the production malfunction monitoring control section is therefore accompanied by a considerable improvement in the operational reliability and efficiency of the food processing machine.

According to another embodiment, the food processing machine also comprises at least one pick-up device, which is set up—in a removal area situated downstream of the transfer area in the transport direction—to take the food products from the suspension hooks until a target number of the picked-up food products is reached in such a way that the food products on the pick-up device are grouped, particularly in batches, with a predefined target number. This pick-up device ensures that the food products that are transported by the suspension hooks are systematically and precisely collected in a defined quantity before being processed further or packed. This enables an efficient and organized handling of the food products, which is particularly advantageous in automated production lines since it improves the trackability and consistency of the produced batches. The food processing machine also comprises a cooking unit for cooking, in particular poaching and/or smoking, the food products that are grouped, particularly in batches, on the pick-up device. The communication between the components in this case takes place via the control device, which coordinates the drive unit of the drive train as well as the pick-up device and the cooking unit. The control device ensures that the correct quantity of food products are transported by the suspension hooks to pick-up device and finally to the cooking unit. This occurs through precise control of the movements of the drive train and pick-up device in order to achieve the target number of the food products in the batches.

According to another embodiment, the food processing machine comprises a pick-up device, which includes a smoke rod. This pick-up device is embodied so that it enables an efficient handling and further processing of food products. The cooking unit is embodied as a smoking and/or cooking chamber, which means that the food processing machine is suitable for not only the production, but also the further processing of food products, for example the smoking or poaching. The pick-up device also preferably comprises a robotic unit, which enables an automation of processes. The robotic unit is set up to move the smoke rod into the removal area, which means that the robotic unit ensures a precise and controlled movement of the smoke rod. This automation reduces manual labor and increases the efficiency of the overall process. In addition, the robotic unit is set up to bring the smoke rod into engagement with the food products that have been picked up by the suspension hooks. This means that the robotic unit is able to take the food products from the suspension hooks and place them onto the smoke rod, which enables a seamless transfer of the food products from the suspension apparatus to the pick-up device. Finally, the robotic unit is set up to transfer the food products from the suspension hooks to the smoke rod, which further automates the transfer process and minimizes the need for manual interventions.

According to another embodiment, the transfer device comprises one or several of the following components: at least one conveyor belt for transporting a food product into the transfer area, a twisting device for twisting a sausage strand into a sausage chain, and a dividing device for dividing and portioning a sausage chain into sausage portions. The conveyor belt enables a continuous and smooth transport of the food products into the transfer area, which increases the efficiency of the loading mode and minimizes the need for manual interventions. The twisting device ensures that sausage strands are automatically twisted into sausage chains, which improves the consistency and quality of the sausage chains produced and at the same time, increases the production speed. Finally, the dividing device divides and portions the sausage chains into uniform sausage portions, which enables precise control of portion sizes and thus meets the requirements for product quality and specification. The control device of the food processing machine plays a central role in coordinating these components. The communication between the control device and the various components such as the conveyor belt, the twisting device, and the dividing device is in particular carried out by corresponding control loops, which ensure that all processes occur in a synchronized and coordinated fashion. This integration and automation of the various components results in a significant increase in the efficiency and productivity of the food processing machine, reduces manual labor, and improves the quality and consistency of the food products produced.

According to another embodiment, the food processing machine comprises a display device with a user interface, wherein the display device is set up to display a position of the suspension hooks and has the user interface for selecting a target position of the suspension hooks for the movement in the correction mode. The display device allows the operator to monitor the current position of the suspension hooks along the transport path in real time, which significantly improves the precision and control of the production process. Providing a user interface also allows the operator to select a specific target position for the suspension hooks to which these are to be moved in the correction mode. This is particularly useful if a manual correction or adjustment of the position of the suspension hooks is required in order for example to rectify errors or meet specific production requirements. The communication between the display device and the control device of the food processing machine typically takes place via an integrated control system, which coordinates both the position detection and the actuation of the drive unit. The display device continuously receives position data from sensors that are installed along the transport path and visually displays this information to the operator. At the same time, the user interface allows the operator to make inputs that are relayed to the control device. The control device interprets these inputs and controls the drive unit correspondingly in order to move the suspension hooks to the selected target position. These additional features contribute to increasing the flexibility and user-friendliness of the food processing machine by making it possible to simply and intuitively monitor and adjust the position of the suspension hooks.

In a second aspect, the present invention provides a control device. This control device has a control interface for the signal-carrying connection with the food processing machine, which enables an effective communication with and control of the various components of the food processing machine. The control interface serves as a communication channel via which control commands and responses can be exchanged between the control device and the food processing machine. This ensures a precise and coordinated control of the food processing machine during operation. The control device is set up to control the food processing machine in a loading mode, wherein it actuates the drive unit to drive the drive train in the transport direction. This means that the control device is able to control the drive unit in such a way that the suspension hooks are moved along the predefined transport path in order to pick up food products from the transfer device. The control device is also set up to control the food processing machine in a correction mode, wherein it actuates the drive unit to drive the drive train counter to the transport direction. Through the embodiment of the control device for transmitting control commands in order to initiate a loading mode and a correction mode, the control device according to the second aspect adopts the advantages mentioned at the beginning in connection with the first aspect of the invention. Advantages and preferred embodiments according to the first aspect of the invention therefore constitute advantages and preferred embodiments according to the second aspect of the invention and vice versa.

In a third aspect, the present invention provides an operating method. The method begins with the movement of a plurality of suspension hooks that are coupled to a drive train along a predefined transport path by a drive unit that is operatively connected to the drive train. According to the method, this movement is produced by controlling the food processing machine in a loading mode, wherein a control device or the control device of the food processing machine actuates the drive unit to drive the drive train in the transport direction. This enables a coordinated and controlled movement of the suspension hooks along the transport path, which is of decisive importance for the subsequent steps of the method. Another step of the method includes the transfer of a food product to the suspension apparatus in a transfer area by at least one transfer device. This transfer device is set up in such a way that it transfers the food product to the suspension apparatus in a precise and reliable way, which is supported by the coordinated movement of the suspension hooks along the transport path. In addition, the method comprises the control of the food processing machine in a correction mode, wherein the control device actuates the drive unit to drive the drive train counter to the transport direction. Through the initiation of a loading mode and a correction mode, the method according to the third aspect adopts the advantages mentioned at the beginning in connection with the first aspect of the invention. Advantages and preferred embodiments according to the first aspect of the invention therefore constitute advantages and preferred embodiments according to the third aspect of the invention and vice versa.

According to another embodiment, the method comprises the monitoring of casing ruptures by a control section that communicates with at least one optical sensor and with the control device, wherein in the event that the control section identifies a casing rupture, the control device actuates the drive unit to drive the drive train counter to the transport direction in the correction mode. This enables a quick and precise correction of the position of the hooks in the event of production stoppages due to casing ruptures.

According to another embodiment, the method comprises the monitoring of a fill level of a hopper of a filling machine of the food processing machine by a control section or the control section that communicates with a fill level sensor and with control device, wherein in the event that the control section identifies a fill level deficit, the control device actuates the drive unit to drive the drive train counter to the transport direction in the correction mode. This enables a quick and precise correction of the position of the hooks in the event of production stoppages due to fill level deficits.

According to another embodiment, the method comprises the monitoring of a weight of food products suspended from the suspension hooks by a control section or the control section that communicates with a weighing cell and with the control device, wherein in the event that the control section identifies a weight deficit, the control device actuates the drive unit to drive the drive train counter to the transport direction in the correction mode. This enables a quick and precise correction of the position of the hooks in the event of production stoppages due to weight deficits.

According to another embodiment, the method comprises the monitoring of production malfunctions of the food processing machine by a control section or the control section that communicates with at least one controller and/or at least one control unit of the food processing machine and with the control device and in the event that the control section identifies a production malfunction, the control device actuates the drive unit to drive the drive train counter to the transport direction in the correction mode. This enables a quick and precise correction of the position of the hooks in the event of production stoppages due to production malfunctions.

According to another embodiment, the method for controlling the food processing machine comprises—before the activation of the correction mode—the step of stopping the suspension apparatus in the event that one, several, or all of the following problems is/are identified: casing ruptures, a fill level deficit, a weight deficit, and a production malfunction. The control device plays a central role in this by continuously collecting data from various sensors and monitoring systems that are installed along the production line of the food processing machine. These sensors could, for example, comprise optical sensors for detecting casing ruptures, weight sensors for measuring the fill level and weight, as well as general production monitoring sensors for detecting malfunctions. As soon as the control device identifies a problem such as a casing rupture, a fill level deficit, a weight deficit, or a production malfunction, it sends a signal to the drive unit in order to correct the movement of the suspension apparatus and thus react to production stoppages due to these error messages. This ensures a complete utilization of the suspension hooks of the suspension apparatus when production resumes.

According to another embodiment, the method also comprises the step of checking a residual length of a predefined number of suspension hooks that have most recently passed through the transfer area before the stopping of the suspension apparatus. The control device is programmed so that it actuates the drive unit to drive the drive train counter to the transport direction in the correction mode only in the event that the residual length is below a predefined limit value. If the residual length falls below a certain threshold and it is not possible to load the residual amount into the suspension hook that has most recently passed through the transfer area, then the correction mode is activated in order to move the suspension hooks counter to the normal transport direction. The checking of the residual length and the required activation of the correction mode ensures that the food processing machine is switched into the correction mode only if it is actually necessary, which increases the efficiency of the operation and avoids unnecessary movements.

### BRIEF DESCRIPTION OF THE DRAWINGS

The embodiments of the present invention are now described below with reference to the accompanying figures. These Figures include the following.

FIG. 1 is a side view that schematically depicts a food processing machine according to the present invention.

FIG. 2a is a perspective view of a detail of a suspension apparatus and a transfer device for the food processing machine according to FIG. 1, specifically in a loading mode.

FIG. 2b is a plan view of a detail of a suspension apparatus and a transfer device for the food processing machine according to FIG. 1 in the loading mode.

FIG. 3a is a perspective view of a detail of the suspension apparatus and transfer device according to FIG. 2a and FIG. 2b, specifically in a correction mode.

FIG. 3b is a plan view of a detail of the suspension apparatus and transfer device according to FIG. 2a and FIG. 2b in the correction mode.

FIG. 4 is a perspective view of a detail of the suspension apparatus and transfer device according to FIG. 2a and FIG. 2b in the loading mode after execution of the correction mode.

FIG. 5 is a schematic block diagram of a food processing machine according to a preferred embodiment.

FIG. 6 is a flowchart schematically illustrating steps of a method for operating a food processing machine according to FIG. 1 or FIG. 5.

### DETAILED DESCRIPTION

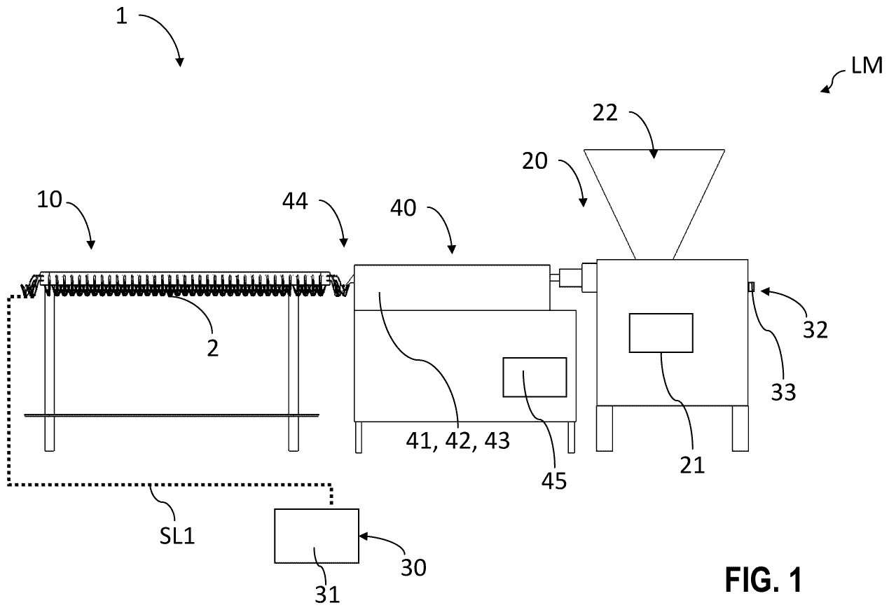

FIG. 1 shows a food processing machine 1 for producing food products 2 in a loading mode LM. The food processing machine 1 comprises a suspension apparatus 10, preferably a filling machine 20, a control device 30, and a transfer device 40.

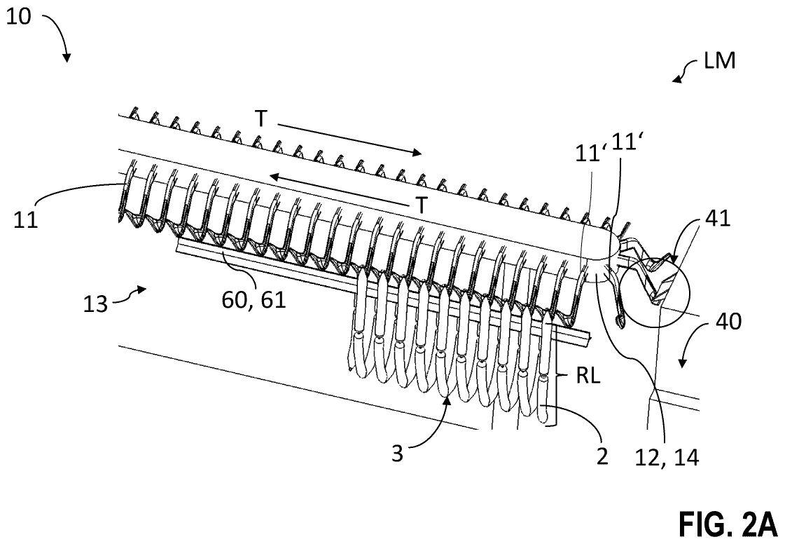

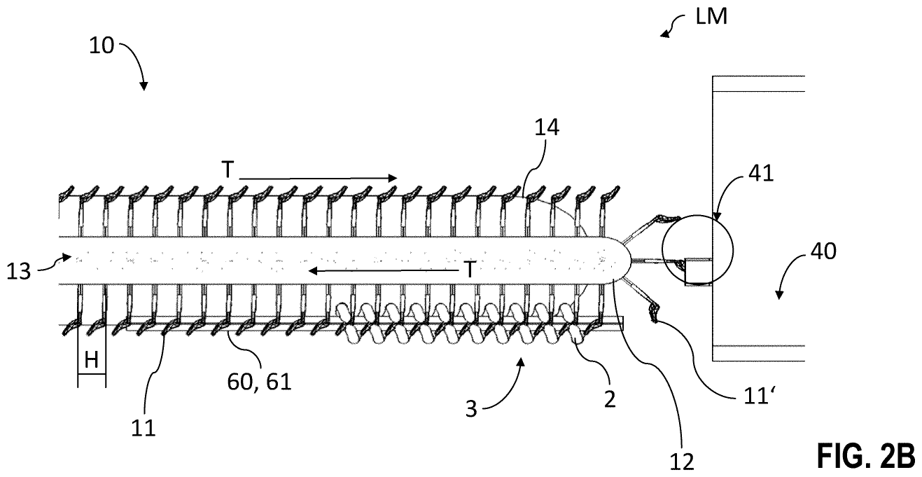

The suspension apparatus 10 comprises a plurality of suspension hooks 11, which are moved along a predefined transport path T (see FIG. 2a). These suspension hooks 11 are coupled to a drive train 12, which is set in motion by a drive unit 13. The suspension hooks 11 are used to transport the food products 2.

The control device 30 is central to the control of the food processing machine 1 and is connected to the drive unit 13. It actuates the drive train 12 in the transport direction T in the loading mode LM. The control device 30 is connected via a signal line SL1 to the food processing machine 1 and communicates with various control sections and sensors in order to monitor and control the operation. Preferably, the control device 30 has a memory 31.

The filling machine 20 comprises a hopper 22 for filling an artificial or natural casing with a sausage filling. The filling machine 20 is equipped with a filling machine controller 21 that can be integrated into the control device 30. This controller enables a precise control of the filling procedure and ensures that the food products 2 are filled in a uniform and efficient way.

The transfer device 40 is responsible for the transfer of the food products 2 to the suspension apparatus 10. In the exemplary embodiment shown, it comprises at least one conveyor belt 41, which is set up to transport a food product 2 into the transfer area 44. The food products 2 are transferred by the transfer device 40 to the suspension hooks 11, which are moved along the transport path 14. In the present case, the transfer device 40 also comprises a twisting device 42 and a dividing device 43. These components work together to transport the food products 2 into a transfer area 44 and to transfer them there to the suspension hooks 11 of the suspension apparatus. Alternatively, the transfer device 40 can also be embodied by a simple chute or other components for bringing food products into the transfer area. The transfer device 40 is equipped with a control unit 45 into which the control device 30 can be integrated. This control unit 45 enables a precise control of the transfer processes and ensures that the food products 2 are correctly and efficiently transferred to the suspension apparatus 10.

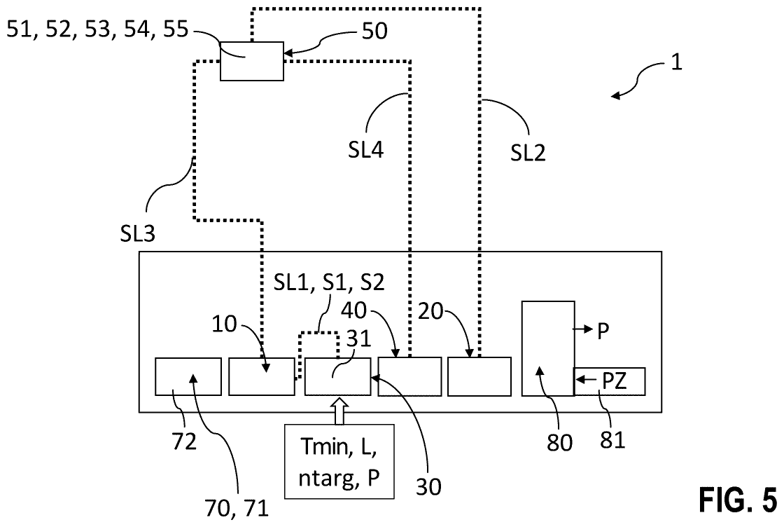

It is preferable to provide an actuating device 32, which in particular comprises a push button 33 that can be manually actuated in order to activate the control device 30 and send control pulses (see FIG. 5). This actuating device 32 enables a manual control of the control device 30 in order—by producing a control pulse, in particular a first control pulse S1—to actuate the drive unit 13 to drive the drive train 12 counter to the transport direction T. With a manual actuation that is shorter than a predefined minimum duration Tmin (see FIG. 5), a second control pulse S2 is produced in order to actuate the drive unit to drive the drive train 12 in the transport direction T. These control pulses serve to control the drive unit 13 and to drive the drive train 12 and to move the suspension hooks 11 in the desired direction.

FIG. 2a and FIG. 2b show a detail of the transfer device 40 and the suspension apparatus 10 of the food processing machine 1 in a loading mode LM.

The control device 30 is set up in such a way that it controls the food processing machine 1 in a loading mode LM. In this mode, the control device 30 actuates the drive unit 13 to move the drive train 12 in the transport direction T. The suspension hooks 11 are positioned so that they move sequentially into the transfer area 44 in order to pick up at least a part of the food product 2 from the transfer device 40.

A pick-up device 60, which comprises a smoke rod 61, is likewise shown in FIG. 2a and FIG. 2b. This pick-up device 60 takes the food products 2 from the suspension hooks 11 in a removal area and groups them in batches 3 with a predefined target number ntarg (see FIG. 5). The pick-up device 60 is set up to cook, in particular poach and/or smoke, the food products 2 in a cooking unit (see FIG. 5).

In the present case, the food products 2 in the form of sausage strands are suspended from the suspension hooks 11. These sausage strands are grouped into batches 3 and transported along the transport path 14.

If a malfunction occurs in the production mode, then as a rule, no further food products 2 are transferred to the suspension apparatus 10 in the transfer area 44 so that at least one suspension hook 11′, which has most recently passed through the transfer area, is empty and will also remain so unless suitable countermeasures are taken. Consequently, an end of a sausage chain whose length is referred to as the so-called residual length is suspended from the most recently loaded suspension hook.

The suspension hooks 11′ that remain empty result in the fact that if the loading mode LM is continued, then the pick-up device 60, which is preferably embodied as a smoke rod 61 in the present case, cannot be fully loaded.

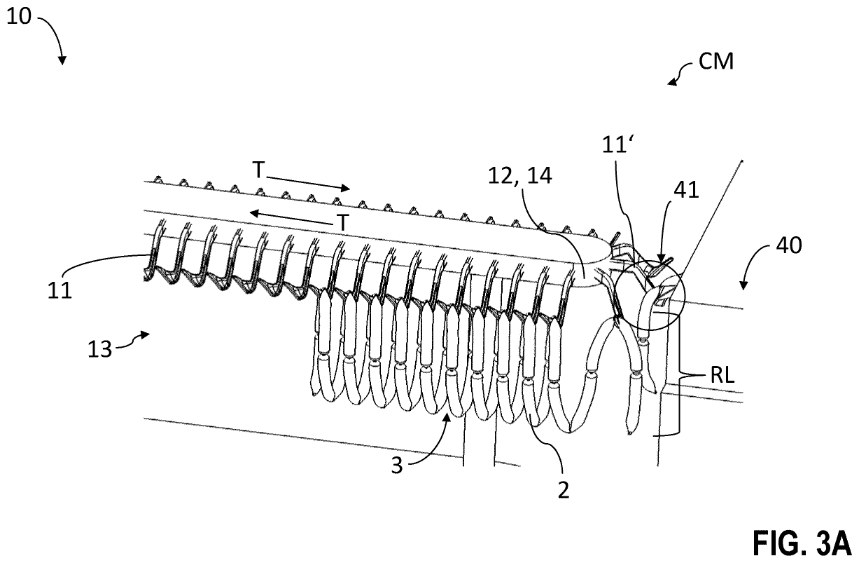

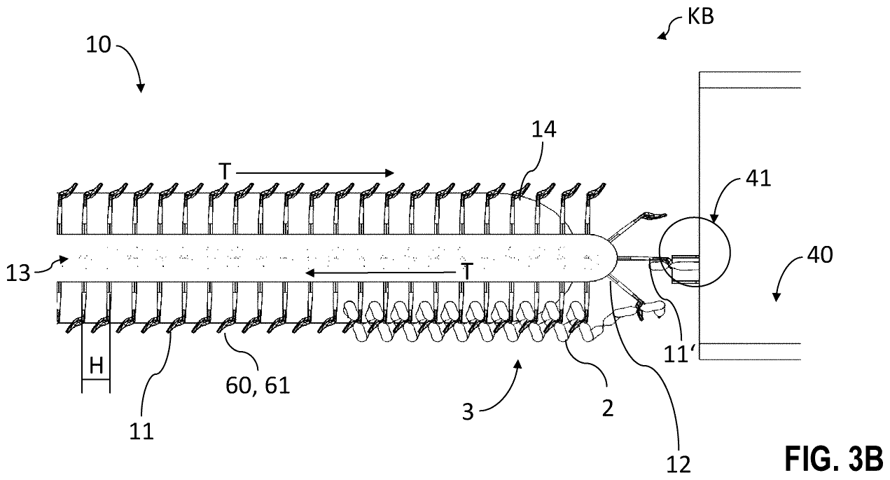

FIG. 3a and FIG. 3b show the transfer device 40 and the suspension apparatus 10 of the food processing machine 1 in a correction mode CM that is intended to ensure a full loading of the pick-up device 60.

In the correction mode CM shown, which is initiated by the control device 30 (see FIG. 1), the drive unit 13 is actuated so that the drive train 12 is moved counter to the transport direction T. This enables a correction of the position of the suspension hooks 11 along the transport path 14.

FIG. 3b shows the hook spacing H between two successive suspension hooks 11. The control device 30 is set up—by producing a control pulse S1—to actuate the drive unit 13 to drive the drive train 12 counter to the transport direction T in such a way that the suspension hooks 11 each move the distance of this hook spacing H counter to the transport direction T.

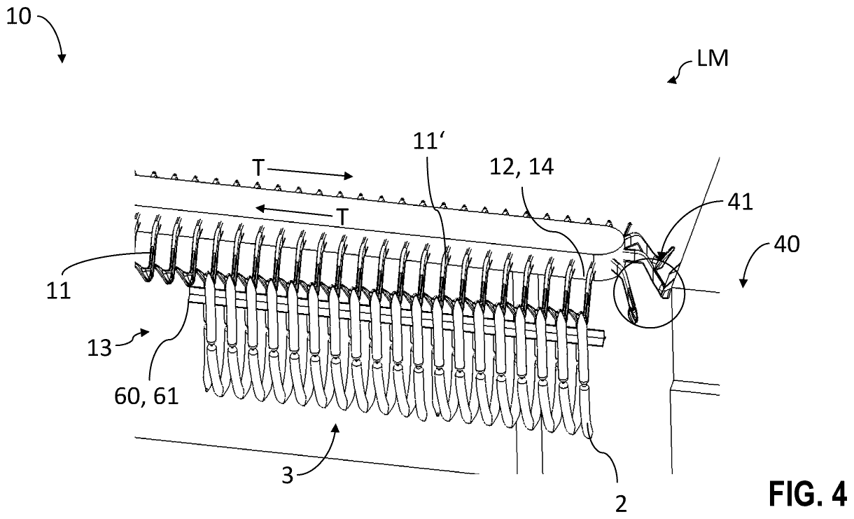

FIG. 4 shows the transfer device 40 and the suspension apparatus 10 of the food processing machine 1 in which, as shown in FIG. 2a and FIG. 2b, a production malfunction has occurred along with the resulting non-loaded suspension hooks 11′, after which operation has been continued in the correction mode CM according to FIG. 3a and FIG. 3b. Due to the actuation by the control device 30, the drive train 12 has moved the previously empty suspension hooks 11′ counter to the transport direction T and back into the transfer area 44. There, the suspension hooks 11′, which are positioned in the transfer area 44 in FIG. 3b after the reverse movement, have then been able to take a food product 2 from the transfer device and now there are no gaps with non-loaded suspension hooks 11 and a complete batch 3 with the desired target number of food products 2 can now be transferred to the pick-up device 60, as shown in FIG. 4.

FIG. 5 shows a schematic depiction of the food processing machine 1, its various components, and their connections. The food processing machine 1 comprises the suspension apparatus 10, the transfer device 40, the control device 30, and preferably the filling machine 20, a display device 80, a cooking unit 70, and a pick-up device 60. The components are connected to one another by different signal lines SL1, SL2, SL3, and SL4.

The suspension apparatus 10, the transfer device 40, and the filling machine 20 are preferably embodied as explained with reference to FIG. 1. In the manner described above, the control device 30 controls the various operating modes of the food processing machine 1, including the loading mode LM and the correction mode CM.

The filling machine 20 is connected to the control device 30 and can be controlled via the signal line SL2. The control device 30 is preferably integrated into the filling machine controller and can actuate the drive unit of the filling machine 20 based on the data provided by the control sections.

The control device 30 is connected to different control sections 50, which are used to monitor and control specific parameters of the food processing machine 1. These control sections comprise, among other things, the casing rupture monitoring control section 51, the fill level monitoring control section 52, the weight monitoring control section 53, and the production malfunction monitoring control section 55. These control sections are connected to the control device 30 via signal lines SL2, SL3, and SL4.

The control device 30 is set up to produce control pulses SL1, S1, and S2 in order to actuate the drive unit of the transport means either in the transport direction T or counter to the transport direction T. The control pulses are produced based on various parameters such as the minimum duration Tmin, the limit value L, the target number ntarg, and the position P.

The different control sections 50 monitor specific parameters of the food processing machine and communicate with the control device 30 in order to actuate the drive unit of the transport means based on the monitored parameters. For example, the casing rupture monitoring control section 51 monitors for casing ruptures and actuates the drive unit in the correction mode if a casing rupture is identified. The fill level monitoring control section 52 monitors the fill level of a hopper and actuates the drive unit in the correction mode if a fill level deficit is identified. The weight monitoring control section 53 monitors the weight of the food products suspended from the suspension hooks and actuates the drive unit in the correction mode if a weight deficit is identified. The production malfunction monitoring control section 55 monitors for production malfunctions and actuates the drive unit in the correction mode if a production malfunction is identified.

The control device 30 is thus centrally responsible for controlling and monitoring the different operating modes and parameters of the food processing machine 1 in order to ensure an efficient, error-free operation.

The cooking unit 70, which is embodied as a smoking and/or cooking chamber 71, is used for cooking the food products. The cooking unit 70 is connected to the pick-up device 60, which takes the food products 2 from the suspension hooks 11 and groups them in batches 3. The smoke rod 61 of the above-described pick-up device 60 can be picked up by a robotic unit 72 of the cooking unit 70, which moves the food products 2 into a smoking and/or cooking chamber 71 of the cooking unit 70 in order to cook them.

The display device 80 comprises a user interface 81, which is set up for displaying a position P of the suspension hooks and selecting a target position TP for the movement in the correction mode CM. The display device 80 displays the position of the suspension hooks and enables the selection of a target position TP. The user interface 81 allows the user to select the target position and to control the food processing machine in the correction mode CM.

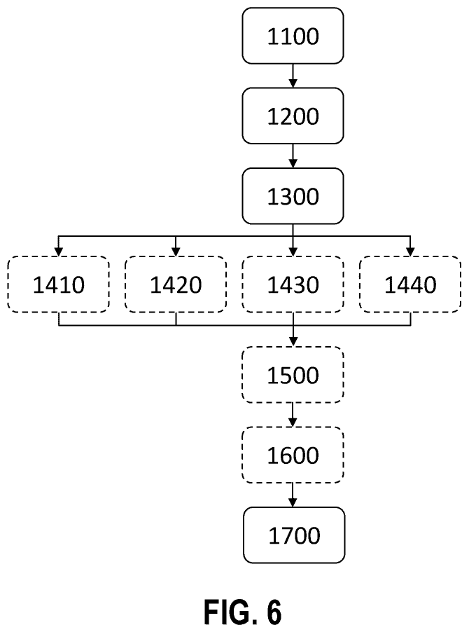

FIG. 6 shows a flowchart illustrating the steps of a method 1000 for operating a food processing machine 1.

The method 1000 begins with step 1100, which describes the movement of a plurality of suspension hooks 11 along a predefined transport path. These suspension hooks 11 are coupled to a drive train 12, which is moved by a drive unit 13 operatively connected to the drive train 12.

The second step 1200 describes the control of the food processing machine 1 in a loading mode LM. In this step, the control device 30 actuates the drive unit 13 in such a way that the drive train 12 is driven in the transport direction T.

In the third step 1300, a food product 2 is transferred to the suspension apparatus 10 in a transfer area 44 by at least one transfer device 40. This enables the sequential picking up of the food products 2 by the suspension hooks 11 during their movement along the transport path T.

Step 1300 in the method 1000 is alternatively or additionally followed by several monitoring steps. These monitoring steps comprise:
Monitoring for casing ruptures by a control section 50 that communicates with at least one optical sensor and with the control device 30 in step 1410. The control device 30 actuates the drive unit 13 counter to the transport direction T in the correction mode CM if a casing rupture is identified.

In step 1420, the monitoring of a fill level of a hopper of a filling machine 20 by a control section 50 that communicates with a fill level sensor and with the control device 30. When a fill level deficit is identified, the control device 30 actuates the drive unit 13 counter to the transport direction T in the correction mode CM.

In step 1430, the monitoring of a weight of food products suspended on the suspension hooks 11 by a control section 50 that communicates with a weighing cell and with the control device 30. When a weight deficit is identified, the control device 30 actuates the drive unit 13 counter to the transport direction T in the correction mode CM.

In addition, in step 1450, the monitoring for production malfunctions of the food processing machine 1 is preferably carried out by a control section 50 that communicates with at least one controller and/or a control unit 45 of the food processing machine 1 and with the control device 30. When a production malfunction is identified, the control device 30 actuates the drive unit 13 counter to the transport direction T in the correction mode CM.

The monitoring steps are followed in step 1500 by the stopping of the suspension apparatus 10 if one or more of the previously monitored problems is/are identified such as casing ruptures, fill level deficits, weight deficits, or production malfunctions.

Step 1600 describes the preferred checking of a residual length RL of a predefined number of suspension hooks 11, which have most recently passed through the transfer area 44 prior to the stopping of the suspension apparatus 10. Preferably, the control device 30 actuates the drive unit 13 in the correction mode CM only if the residual length RL is below a predefined limit value L.

Finally, step 1700 describes the control of the food processing machine 1 in the correction mode CM, wherein the control device 30 actuates the drive unit 13 to drive the drive train 12 counter to the transport direction T.

What is claimed is:

1. A food processing machine for producing food products, comprising:
a suspension apparatus having a plurality of suspension hooks that are coupled to a drive train and having a drive unit that is operatively connected to the drive train and moves the suspension hooks along a predefined transport path,
a control device that controls the food processing machine in a loading mode, wherein the control device actuates the drive unit to drive the drive train in a transport direction,
at least one transfer device is provided to transfer a food product to the suspension apparatus in a transfer area,
wherein the suspension hooks are moved sequentially into the transfer area in the loading mode when moving along the transport path to pick up at least a part of the food product from the transfer device,
wherein a hook spacing between two successive suspension hooks is stored in the control device, and
the control device also controls the food processing machine in a correction mode in which the control device produces a control pulse to actuate the drive unit to drive the drive train in a direction counter to the transport direction in such a way that the suspension hooks each move a distance of the hook spacing counter to the transport direction.

2. The food processing machine according to claim 1, further comprising:
an actuating device including a push button, which is set up, when it is manually actuated, to cause the control device to produce the control pulse.

3. The food processing machine according to claim 2, wherein the control pulse is a first control pulse and the actuating device, when it is manually actuated with at least a predefined minimum duration, causes the control device to produce the first control pulse and when the actuating device is manually actuated for shorter than the predefined minimum duration, causes the control device to produce a second control pulse to drive the drive train in the transport direction.

4. The food processing machine according to claim 1, wherein the transfer device has a control unit and the control device is integrated into the control unit of the transfer device.

5. The food processing machine according to claim 1, further comprising:
a filling machine for filling an artificial or natural casing with a sausage filling,
wherein the control device is integrated into a filling machine controller of the filling machine.

6. The food processing machine according to claim 5, further comprising:
at least one casing rupture monitoring control section, which, to monitor for casing ruptures, communicates with at least one optical sensor and with the control device, and in the event that the control section identifies a casing rupture, the control device actuates the drive unit to drive the drive train in a direction counter to the transport direction in the correction mode.

7. The food processing machine according to claim 1, further comprising:
at least one fill level monitoring control section, which, to monitor a fill level of a hopper of a filling machine of the food processing machine, communicates with a fill level sensor and with the control device, and in the event that the control section identifies a fill level deficit, the control device actuates the drive unit to drive the drive train in a direction counter to the transport direction in the correction mode.

8. The food processing machine according to claim 1, further comprising:
at least one weight monitoring control section, which, to monitor a weight of food products suspended on the suspension hooks, communicates with a weighing cell and with the control device, and in the event that the control section identifies a weight deficit, the control device actuates the drive unit to drive the drive train in a direction counter to the transport direction in the correction mode.

9. The food processing machine according to claim 1, further comprising:
at least one production malfunction monitoring control section, which, to monitor for production malfunctions of the food processing machine, communicates with at least one controller of the food processing machine and with the control device, and in the event that the control section identifies a production malfunction, the control device actuates the drive unit to drive the drive train in a direction counter to the transport direction in the correction mode.

10. The food processing machine according to claim 1, further comprising:
at least one pick-up device, which- in a removal area situated downstream of the transfer area in the transport direction- takes the food products from the suspension hooks until a target number of picked-up food products is reached in such a way that the food products are grouped in batches, with a predefined target number on the pick-up device, and
a cooking unit for cooking the food products that are grouped in batches, on the pick-up device.

11. The food processing machine according to claim 10, wherein the pick-up device comprises a smoke rod and the cooking unit is embodied as a smoking or cooking chamber, and
wherein the pick-up device also comprises a robotic unit, which moves the smoke rod into the removal area and brings it into engagement with the food products that have been picked up by the suspension hooks to transfer the food products from the suspension hooks to the smoke rod.

12. The food processing machine according to claim 1, wherein the transfer device comprises at least one of the following:
at least one conveyor belt for transporting a food product into the transfer area,
a twisting device for twisting a sausage strand into a sausage chain, and
a dividing device for dividing and portioning a sausage chain into sausage portions.

13. The food processing machine according to claim 1, further comprising:
a display device with a user interface, wherein the display device displays a position of the suspension hooks and has the user interface for selecting a target position of the suspension hooks for movement in the correction mode.

14. A control device for controlling the food processing machine of claim 1,
wherein the control device has a control interface for a signal-carrying connection with the food processing machine and controls the food processing machine in a loading mode, wherein the control device actuates a drive unit of the food processing machine to drive a drive train of the food processing machine, which is coupled to a plurality of suspension hooks), in a transport direction, and
wherein a hook spacing between two successive suspension hooks is stored in the control device and the control device controls the food processing machine in a correction mode in which the control device actuates the drive unit—by producing a control pulse—to drive the drive train in a direction counter to the transport direction in such a way that the suspension hooks each move a distance of the hook spacing counter to the transport direction.

15. A method for operating a food processing machine, comprising the steps:
moving a plurality of suspension hooks, which are coupled to a drive train, along a predefined transport path by a drive unit that is operatively connected to the drive train,
controlling the food processing machine in a loading mode, wherein a control device of the food processing machine actuates the drive unit to drive the drive train in a transport direction,
transferring a food product in a transfer area to the suspension apparatus by at least one transfer device, and
controlling the food processing machine in a correction mode, wherein a hook spacing between two successive suspension hooks is stored in the control device and the control device actuates the drive unit—by producing a control pulse—to drive the drive train in a direction counter to the transport direction in such a way that the suspension hooks each move a distance of the hook spacing counter to the transport direction.

16. The method according to claim 15, further comprising at least one of the following steps:
monitoring for casing ruptures by a control section that communicates with at least one optical sensor and with the control device, wherein in the event that control section identifies a casing rupture, the control device actuates the drive unit to drive the drive train in a direction counter to the transport direction in the correction mode,
monitoring of a fill level of a hopper of a filling machine of the food processing machine by the control section that communicates with a fill level sensor and with the control device, wherein in the event that control section identifies a fill level deficit, the control device actuates the drive unit to drive the drive train in a direction counter to the transport direction in the correction mode,
monitoring of a weight of food products suspended on the suspension hooks by the control section that communicates with a weighing cell and with the control device, wherein in the event that control section identifies a weight deficit, the control device actuates the drive unit to drive the drive train in a direction counter to the transport direction in the correction mode, and
monitoring for production malfunctions of the food processing machine by the control section that communicates with at least one controller of the food processing machine and with the control device, and in the event that control section identifies a production malfunction, the control device actuates the drive unit to drive the drive train in a direction counter to the transport direction in the correction mode.

17. The method according to claim 16, wherein before an activation of the correction mode, the method further comprises the step:
stopping of the suspension apparatus when at least one of the following is identified:
casing ruptures,
a fill level deficit,
a weight deficit, and
a production malfunction.

18. The method according to claim 17, further comprising the step:
checking a residual length of a predefined number of suspension hooks that have most recently passed through the transfer area before the stopping of the suspension apparatus, wherein the control device actuates the drive unit to drive the drive train in a direction counter to the transport direction in the correction mode only in the event that the residual length is below a predefined limit value.
